(19) United States
(12) Patent Application Publication
(10) Pub. No.: US 2008/0039089 A1
(43) Pub. Date: Feb. 14, 2008

(54) System and Method for Providing Dynamically Configurable Wireless Communication Network

(76) Inventors: William H. Berkman, New York, NY (US); John C. Boot, Clarksburg, MD (US)

Correspondence Address: CAPITAL LEGAL GROUP, LLC, 1100 River Bay Road, Annapolis, MD, 21409, US

(21) Appl. No.: 11/464,085

(22) Filed: Aug. 11, 2006

(51) Int. Cl. H04Q 7/20

(52) U.S. Cl. 455/436

(57) ABSTRACT

A system and method of providing wireless communications services within a first geographical area using a network comprising a group of cells, wherein a plurality of the cells have overlapping coverage areas is provided. In one embodiment, the method includes storing rules for transferring user device communications between cells; establishing wireless communications with a plurality of user devices via the group of cells; monitoring one or more communications parameters of the communications through at least one of the cells of the group; determining that one or more communication parameters monitored has reached a first value; changing communication frequencies used by a plurality of the cells of the group for wireless communications with the user devices; modifying the communication range of one or more cells of the group from a first size to a second size; determining, based on the rules, whether one or more wireless communications should be handed-off from a first cell of the group to a second cell of the group; and handing-off one or more wireless communications from a first cell of the group to a second cell of the group in accordance with the determining.

### FIELD OF THE INVENTION

The present invention generally relates to systems and methods for providing a wireless network, and more particularly to a system and method of data and voice communication between wireless cells of different scale.

### BACKGROUND OF THE INVENTION

Wireless communication providers have been developing wireless infrastructure to support mobile telephone communications in various areas and among various population sizes. These providers set up cell sites comprising cell towers with accompanying base stations. A macrocell site may serve an area, referred to as a macrocellular site, which may be a few miles in diameter.

With the proliferation of cell phones and the emergence of broadband services, the demand for wireless network capacity is increasing. In order to provide a higher capacity with limited frequency spectrum, innovative microcellular networks and picocellular networks also are being implemented.

A microcellular network is divided into one or more smaller geographic regions referred to as microcells. Each microcell sites may have a coverage diameter on the order of several hundred meters and includes a wireless transceiver (or base station) through which users connect to the network. A picocellular network typically is divided into one or more even smaller regions called picocells. Each picocell site has an associated wireless transceiver (or base station) which serves users within approximately a 10 to 300 meter radius. Typically, microcells and picocells are intended to cover areas ranging from a small urban corridor to a convention center or a single room in an office environment.

The different sized cell networks (macrocellular, microcellular and picocellular) have different advantages and disadvantages. As these various wireless networks proliferate, there is a growing need for systems and methods of integrating the various networks to take advantage of a given network's strengths while compensating for weaknesses. Various embodiments of the present invention may satisfy this need and provide other advantages over prior systems.

### SUMMARY OF THE INVENTION

The present invention provides a system and method of providing wireless communications services within a first geographical area using a network comprising a group of cells, wherein a plurality of the cells have overlapping coverage areas is provided. In one embodiment, the method includes storing rules for transferring user device communications between cells; establishing wireless communications with a plurality of user devices via the group of cells; monitoring one or more communications parameters of the communications through at least one of the cells of the group; determining that one or more communication parameters monitored has reached a first value; changing communication frequencies used by a plurality of the cells of the group for wireless communications with the user devices; modifying the communication range of one or more cells of the group from a first size to a second size; determining, based on the rules, whether one or more wireless communications should be handed-off from a first cell of the group to a second cell of the group; and handing-off one or more wireless communications from a first cell of the group to a second cell of the group in accordance with the determining.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of an example embodiment of a wireless cell topology serving a geographical area;

FIG. 2 is a block diagram of an example embodiment of various cells serving a geographical area;

FIG. 3 is a flow chart of a process for handling a communication received from a user device according to one example embodiment of the present invention;

FIG. 4 is a flow chart of a process for gathering network and communication parameters according to an example embodiment of the present invention;

FIG. 5 is a flow chart of a process for processing hand-off rules according to an example embodiment of the present invention; and

FIG. 6 is a flow chart of an example embodiment of communication according to one embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, base station, cell, cell site, wireless transceiver, user device, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, base station, cell, cell site, wireless transceiver, user device, development interfaces, and hardware are omitted so as not to obscure the description of the present invention. As will be evident to those skilled the art, the terms cell and cell site have been used interchangeably throughout herein and are mean to connote the same item, which may be, for example purposes only, a Wifi wireless transceiver or a base station (e.g., WiMAX or mobile phone base station).

### Topology and Networks:

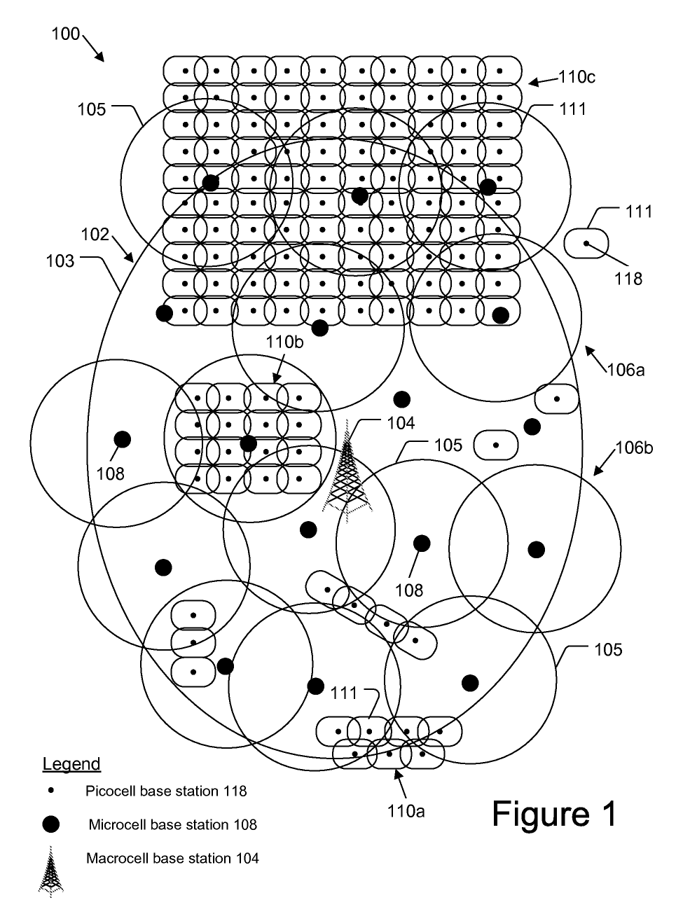

A topology 100 of communication networks is shown in FIG. 1, including a macrocellular network 102, multiple microcellular networks 106 and multiple picocellular networks 110. One skilled in the art will appreciate that various topologies may be implemented in varying geographic areas to deliver communication services, such as voice communication services and data communication services. Although, only one macrocell 103 is shown, in other embodiments multiple macrocells may cover a geographical area. For example, over a large geographical region several overlapping macrocells may form a macrocellular network. The area of coverage for a given cell is represented by the circles or ellipses in FIG. 1. The specific shape of a cell's area may vary according to the embodiment.

Each macrocell 103 of a macrocellular network 102 may include a cell tower having a base station 104 for communicating with registered user devices located within the macrocell 103. Macrocells typically serve a few city blocks, a town, small city, or other such area. Exemplary implementations of the macrocellular network 102 may support analog and/or digital mobile telephone and other wireless telephone communications, broadband data services, such as voice over Internet Protocol (VoIP), internet web browsing, audio streaming, and video-on-demand, and other high data rate voice and data services.

Each microcell 105 of a microcellular network 106 may include a base station 108 for communicating with user devices located within the microcell 105. Note that in the example embodiment depicted, the microcells 105 of the microcellular networks 106 are significantly smaller than the macrocell 103 of the macrocellular network 102. Microcells typically cover an area on the order of several hundred meters in diameter and may serve areas such as an auditorium, shopping complex, apartment building, park, rest stop, gas station, train station, restaurant, street, city block, or other such area (any of which may also be served by another type of cell as well). Exemplary implementations of the microcellular networks 106 may support wireless telephone communications and broadband data services, such as voice over IP (VoIP), internet web browsing, audio streaming, video-on-demand and other high throughput voice and data services. In one example embodiment, microcells may be implemented with a Wifi access point (e.g., an access point substantially compliant or compatible for communications with IEEE 802.11a,b,g or n) or WiMAX base station (transceiver substantially compliant or compatible for communications with IEEE 802.16d or e). Advantages of a microcellular network may include higher throughput (due to fewer users being expected to occupy the smaller cell), lower power requirements for transmitters, increased radio frequency reuse (due to reduced cell size), and lesser expense. A disadvantage of a microcellular network is that for mobile customers, the smaller cell size means hand-offs from one cell to another may occur more frequently within the microcellular network 106 than within the macrocellular network 102.

Each picocell 111 of a picocellular network 110 may include a base station 118 for communicating with user devices located within the picocell 111. The picocells 111 are even smaller than the microcells 105. In various embodiments a picocell 111 may have a radius of approximately 10 meters, (such as a picocell which serves a single office), up to a larger radius of approximately 300 meters, such as a picocells which serve an auditorium, apartment building unit, park, rest stop, gas station, train station, restaurant, street, or other such area (any of which may also be served by another type of cell as well). Preferred implementations support wireless voice communications and broadband and other high data rate data and voice services. Exemplary implementations of the picocellular networks 110 support wireless telephone communications and broadband data services, such as voice over IP (VoIP), internet web browsing, audio streaming, video-on-demand and other high throughput voice and data services. In one example embodiment, picocells may be implemented with a Wifi access point (e.g., an access point substantially compliant or compatible for communications with IEEE 802.11a, b, or g), and may, for example, communicate with lower transmission power to reduce the radius of coverage. Like the microcellular networks, a picocellular network offers the advantages of high throughput, low power requirements for transmitters and increased radio frequency reuse due to reduced cell size. A disadvantage of a picocellular network is that for mobile customers, the smaller cell size means hand-offs from one cell to another may occur more frequently than within a microcellular network 106 or a macrocellular network 102.

In a market economy multiple service providers may implement networks with overlapping regions. Accordingly, the topology 100 may vary even in similar geographic regions based on competition and design choices. In FIG. 1, for example, the picocellular network 110c encompasses a large area and may compete (or cooperate) with microcellular network 106a of another provider to deliver similar services within an area.

Further, one provider may provide overlapping macrocellular networks 102, microcellular networks 106 and picocellular networks 110. A given network provider may, for example, have both a microcellular network 106b and have a picocellular network 110b that provides coverage to an area of high demand, such as in an area having a high population density. Some providers may include a picocellular network 110a so as to extend coverage to areas not reached by the microcellular network 106. Similarly, a provider may include one or more microcellular networks or picocellular networks to expand the service area of its macrocellular network. In particular, macrocellular networks and some microcellular networks are known to have several ‘dead’ spots where reception is poor or unavailable, such as within many buildings, (e.g., skyscrapers, airports or other buildings having a construction which may partially shield the inner compartments from some radio frequencies). In such case the macrocell network provider may desire to access one or more microcells or picocells that provide wireless services within the “dead” area. Likewise, a microcellular network can benefit from overlapping picocellular network coverage.

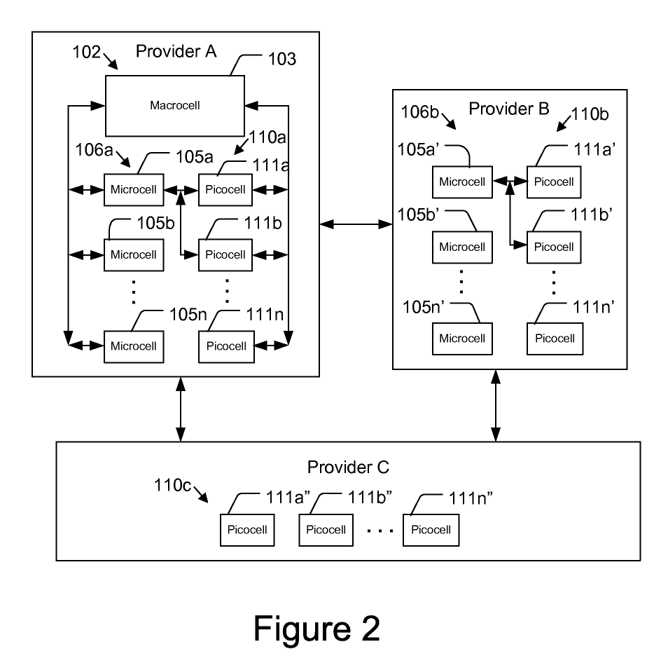

FIG. 2 shows an example in which three network providers have overlapping networks within a given geographical area. Provider A, for example, may be a macrocellular network 102 operator, while also having a microcellular network 106a and multiple picocellular networks 110a. The number of microcells 105a-n or picocells 111a-n may vary from 0 to any number of cells in various embodiments. In the same (or an overlapping geographical area), provider B may operate a microcellular network 106b and a picocellular network 110b. In various embodiments the number of microcells 105a′-n′ or picocells 111a′-n′ operated by provider B may vary from 0 to any number of cells. Provider C may, for example, be a picocellular network 110c operator. In various embodiments the number of picocells 111a″-n″ operated by provider C may vary from 0 to any number of cells.

Of significance is that multiple providers may be present in a given area. Each provider may have varying resources and varying coverage within an area. For mobile customers moving within the area, service may be handed off from one cell 103, 105, 111 to another cell 103, 105, 111, as the customer moves out of range of such one cell and into the range of another cell or for other reasons described herein. Of particular interest here are hand-offs (transfer of service) which may occur between a cell of a first cell size and a cell of a second cell size. In some cases it may be desirable to hand-off service from the macrocellular network 102 to a microcellular network 106 or picocellular network 110 having overlapping or adjacent coverage with a given macrocell 103. In other cases it may be desirable to hand-off service from a microcellular network 106 to a picocellular network 110 or a macrocellular network 102 having overlapping or adjacent coverage within a given microcell 105. In still other cases it may be desirable to hand-off service from a picocellular network 110 to a microcellular network 106 or macrocellular network 102 having overlapping coverage within or adjacent to a given picocell 111. These hand-offs are depicted in FIG. 2 by arrowed lines. In particular, a customer of provider A communicating via a macrocell 103 within the macrocellular network 102 may have their communications handed off to a microcell 105 in provider A's microcellular network 106a; to a picocell 111 in provider A's picocellular network 110a; to a microcell 105 in a provider B's microcellular network 106b; or to a picocell 111 in a provider B's or provider C's picocellular networks 110b, 110c. A customer of provider A communicating via the microcellular network 106a may have their communications handed-off to a macrocell 103, microcell 105 or picocell 111 of provider A, B or C's networks 102, 106a,b, 110a-c. Similarly, a customer of provider A communicating via the picocellular network 110a may have their communications handed-off to a macrocell 103, microcell 105 or picocell 111 of provider A, B or C's networks 102, 106a, b, 110a-c.

A customer of provider B communicating via a microcell 105 within the microcellular network 106b may have their communication handed off to a picocell 111 in provider B's picocellular network 110b; to a picocell 111 in provider A's or provider C's picocellular networks 110a, 110c; or to a macrocell 103 in provider A's macrocellular network 102. Similarly, a customer of provider B accessing the picocellular network 110b may have their communications handed-off to a macrocell 103, microcell 105 or picocell 111 among provider A, B and C's networks 102, 106a,b, 110a-c.

A customer accessing a picocell 111 within provider C's picocellular network 110c may have their communication handed off to a picocell 111 or microcell 105 in provider B's picocellular network 110b or microcellular network 106b; or to a picocell 1111, microcell 105, or macrocell 103 among provider A's networks 102, 106a, 110a. Note that hand-offs may occur for any cell of any given network to any cell of another network having overlapping (or in some instances adjacent coverage), whether or not served by the same or a different network operator.

According to an embodiment of the present invention, rules are defined to determine the conditions where a given wireless communication is to be handed off from one network to another network. One skilled in the art will appreciate that additional rules may be included to determine the conditions under which a given wireless communication is to be handed off from one cell to another cell within the same network.

### Communication Processes:

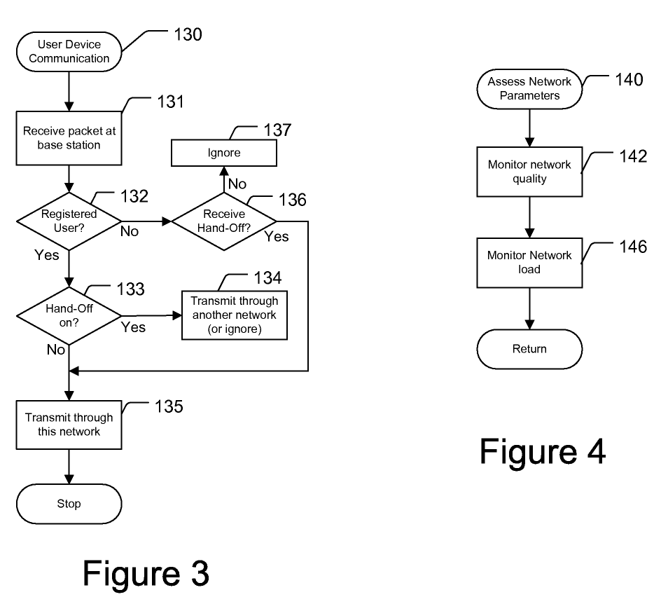

FIGS. 3-5 are flow charts of software processes that may be implemented, for example, by a cell site (e.g., base station/wireless transceiver 104, 108, 118), or a remote access controller that communicates with the cell sites, within a given cell of a picocellular network 110, microcellular network 106 or macrocellular network 102. FIG. 3 shows a process 130 which executes when a packet communication is received. At step 131 the packet(s) is received. At step 132, it is determined whether the communication is from a registered user of the cell site (macrocell, microcell, or picocell). If it is from a registered user, then at step 133 it is determined whether the communication is to be handed off to another cell (e.g., based on communication parameters or if hand-off has been selected). If the communication is to be handed-off, then at step 134 the communication is handed-off (i.e., transferred) to another cell (macrocell, microcell, or picocell). In particular, handing off the communication may include transmitting the communication from the cell site, then receiving the communication at the other cell site. For example, the cell site may repackage the communication with a hand-off request, then transmit the repackaged communication. In another embodiment, the communication may be ignored, such as in an embodiment where the other cell or network has previously been notified to accept the communication. In such case, the transmission from the user device is received directly at the cell site of the other network and accepted. If handing-off has not been selected, then at step 135 the communication is transmitted through the receiving cell site's network.

For the case where the incoming communication is not from a registered user, at step 136 it is determined (e.g., by inspecting the communication) whether the receiving cell site has been authorized to accept the communication, (e.g., whether the communication has been handed off to this network). If not so authorized, then the communication may be ignored. If authorized, then at step 135 the communication is transmitted through the network of the cell site. In various embodiments the authorization to receive the communication from the non-registered user may occur by processing the incoming packet to determine if a hand-off has been requested and accepting the hand-off. In other cases, the hand-off previously may have been authorized, such as in response to a communication from the other base station. In such case, the incoming packet is inspected to determine whether it is part of a communication being handed-off to this base station. Any of the many methods of handing off wireless communications known in the art may be suitable for various embodiments of the present invention.

FIG. 4 shows a process 140 for gathering information to be used in executing and/or assessing the rules for communications received at the cell sites executing the process. At step 142 network parameters are determined to assess, for example, the quality of service within the network and/or cell. These parameters may be useful in determining whether the network's quality of service (QOS) is satisfactory for servicing a given wireless communication, communications, or for a given type of communication service. For example, at step 142 data latency and/or error rates may be determined. At step 146 parameters are determined to evaluate the load of a cell (e.g., the available capacity, the average capacity, throughput per period of time). These parameters may be useful for determining whether communications should be redistributed or redirected (e.g., based on the rules) so as to balance the load within a given network (or offload some of the demand to another network). In various embodiments the parameters of process 140 may be periodically sampled, sampled in response to specific events, or sampled as part of other communication and maintenance processes.

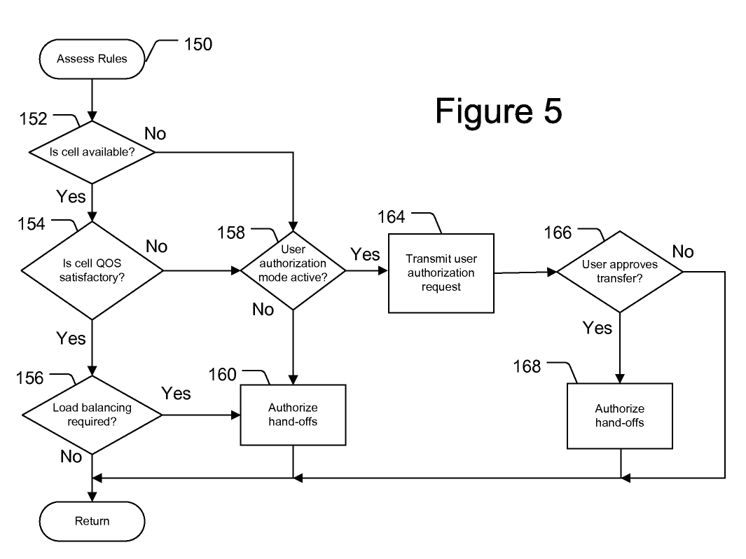

FIG. 5 shows an embodiment of a process 150 which is executed periodically or aperiodically to determine whether communications should be handed off to another cell (which may be a different cell type in the same or a different network). In this embodiment, the process is implemented in the cell site and in other embodiments may be implemented at a central controller that implements the process for numerous cell sites and, in some instances, numerous networks. In some embodiments the process 150 also may be executed in response to specific events. For example, in one embodiment the process 150 is executed in response to a new wireless communication being initiated (e.g., requested) by a user device.

At steps 152, 154, and 156 various rules are assessed to determine whether service is to be handed-off for one or more communications. These rules or others may be assessed in various orders for differing embodiments. In some embodiments, a user authorization mode is implemented. When the user authorization mode is active, handing-off of a communication may first require user authorization. However, some rules may not require user authorization even when user authorization mode is active.

At step 152, a rule is assessed to determine cell site availability. If the cell site of the network (e.g., that is receiving the user device request or identified by a central controller) is available (e.g., operable, can process request with given load, etc.), then at step 154 the next rule is assessed. If that cell site of the network is not sufficiently available, then at step 158, it is determined whether user authorization mode is active. When user authorization mode is found to be inactive at step 158, handing-off of the user's service is permitted without user authorization. At step 160, handing-off is authorized and the information of the communication is transmitted to another cell site to hand-off service of the communication to that cell site.

Similarly, at step 154 another rule may be assessed to determine whether the quality of service (“QOS”) provided by the cell site of the network is satisfactory (e.g., meets predetermined conditions for the user and/or data) at that time (e.g., time of the request or during periodic assessment). If the QOS is satisfactory, then at step 156 the next rule is assessed. If the QOS is not satisfactory, then at step 158 it is determined whether user authorization mode is active. If user authorization mode is found to be inactive at step 158, handing-off service is permitted without user authorization. At step 160, handing-off is authorized and the information of the communication is transmitted to another cell to hand-off service of the communication to that cell.

At step 156, yet another rule may be assessed to determine whether load balancing is to be implemented based, for example, on the information gathered regarding the available capacity of the cell (e.g., step 146 of FIG. 4). If so, then at step 160 hand-offs are authorized to implement load balancing and the information of the communication is transmitted to another cell to hand-off service of the communication to that cell.

While not shown in FIG. 5, even if a user authorization system is implemented, in some instances the hand-off may occur even if the user authorization mode is active and the user has not authorized the hand-off. For example, if both cells are owned by the same operator and/or if there is no additional expense to the user, some embodiments may hand-off the communication irrespective of whether the user has authorized hand-offs. Some embodiments may only request authorization from the user (and will otherwise hand-off the communication) if the user will incur costs such as if the new network will assess a fee or if the user has exceeded a predetermined amount of use (e.g., exceeded minutes) on the network to which the communication is to be transferred. Information of whether user authorization mode is active may be included in the request from the user device, may be determined based on user device, and/or may be stored in memory (remotely or locally) and retrieved (based on unique identifier received from the user device) upon receiving the request.

When user authorization mode is found to be active at step 158, a process for requesting authorization to hand off the communication is begun. At steps 164 a request may be transmitted to request authorization of the user to hand-off the communication made. Specifically, the request may be transmitted to the user device instigating a given communication (e.g., transmitting a request to communicate via the cell). At step 166, the user response is received and assessed. If authorized by the user, then at step 168 the hand-off is authorized for the corresponding communication and the information of the communication is transmitted to another cell to hand-off service of the communication to that cell. If not authorized at step 166, the process is completed and the hand-off does not occur unless other conditions are met.

When a hand-off of service is to occur for one or more communications, the cell site may transmit a control communication to the other cell site (which may be in the same or another network) requesting that such one or more wireless communications be accepted at the other cell, which may be in another network. Such request may be made for a specific communication, for all communications occurring within a given time period, or for all communications until further notice. One skilled in the art will appreciate that other parameters also may be monitored to determine which communication(s), and during which time periods, of a cell are to be handed off.

### Hand-Off Rules:

In some embodiments a database of rules is maintained and accessed to determine whether a given communication or multiple communications are to be handed-off from a given cell site to another cell site. In particular, rules may be maintained to determine whether a cell site of a given cell size is to hand-off communications to a cell site servicing a cell of a different cell size. Some of these rules have been described above with regard to the flows charts of FIGS. 3-5. Following are more detailed examples of rules that may be implemented:

Rules for a cell site 118 of a picocell 111, cell site 104 of a macrocell 103, and/or cell site 108 of microcell 105 (or alternately for a remote computer system in operative control of one or more cells 111, 105, and/or 103):

1a. When (i) a cell 111, 105, or 103 cannot be utilized by a customer of the network provider, such as when service is down; and (ii) another cell 111, 105, or 103 of the same provider is accessible; then (iii) hand-off user communications to the other cell 111, 105, or 103 of the common provider. For this rule and those below, in some embodiments, it may be preferable to hand-off communications to a cell of the same type when available (e.g., microcell to microcell) and in other instances it may be desirable to hand-off communications to a smaller cell type (e.g., microcell to picocell) such as in urban areas or to a larger cell type (e.g., microcell to macrocell) in rural areas.

1b. When (i) a cell 111, 105, or 103 cannot be utilized by a customer of the network provider, such as when service is down; and (ii) a cell 111, 105, or 103 of another provider is accessible; then (iii) hand-off user communications to a cell 111, 105, or 103 of the other provider.

2a. When (i) a cell 111, 105, or 103 of a network provider cannot satisfy certain network conditions (e.g., cannot meet threshold quality of service) for a customer communication; and (ii) another cell 111, 105, or 103 of the same provider is accessible; then (iii) hand-off user communications to the other cell 111, 105, or 103 of the common provider.

2b. When (i) a cell 111, 105, or 103 of a picocellular network provider cannot satisfy certain network conditions (e.g., cannot meet threshold quality of service) for a customer communication; and (ii) a cell 111, 105, or 103 of another provider is accessible; then (iii) hand-off user communications to the cell 111, 105, or 103 of the other provider.

3. When a picocell 111 which is handling a communication or receives a new request for communications and the communication (or request) is from a customer of the network provider which operates the picocell and also operates another overlapping microcell and macrocell, hand-off the communication to the macrocell if conditions permit (e.g., available, bandwidth is available, and QoS is satisfactory). If conditions do not permit hand-off to the macrocell, hand-off communications to the microcell 105 if conditions permit (e.g., available, bandwidth is available, and QoS is satisfactory).

4. When a microcell 105 which is handling a communication or receives a new request for communications and the communication (or request) is from a customer of the network provider which operates the picocell and also operates another overlapping macrocell, hand-off the communication to the macrocell if conditions permit (e.g., available, bandwidth is available, and QoS is satisfactory). In some embodiments (e.g., which operate in urban areas) it may be more desirable to hand-off communications to smaller cell types (e.g., from macrocell to microcell and from microcell to picocell).

In implementing these rules, before allowing a communication to be handed off for a given customer, in some embodiments the process may request authorization from the user (e.g., inform the customer that service can be provided at additional cost if the customer agrees). In addition, in some embodiments rule 1a may be preferable over rule 1b and rule 2a may be preferable over rule 2b with no preference among rules 1-4. As will be evident to those skilled in the art, other rules and considerations may be used to determine which cell handles communications. For example, other embodiments may consider the type of user device, the type of data (e.g., voice versus video) being communicated (or requested), the location of the user (e.g., inside or outside), movement of the user (e.g., stationary or mobile), and other such factors to determine which cell type should provide communications and/or whether service of a communication should be handed-off.

In some embodiments each hand-off event from one network provider to a different network provider may be tracked (e.g., stored in a computer). For example, the number of calls, the duration of calls, the number of communications, the amount of data or other communication data may be tracked (e.g., monitored and stored in memory) to provide a financial accounting among network providers A, B and C. In some cases, the operators may agree to swap capacity at no charge. In other cases, transfer payments may be made to compensate each provider for services rendered based on duration and/or data volume via an automated computer program executed on a computer system. The data may be processed and cross charged. Charges may be at fixed rate, at a rate based on time units or data units, or may vary according to time of day, day of week, and location. The funds may be electronically transferred monthly or at another agreed upon time.

In addition to or in conjunction with handing-off user device communications, the cells described herein may be configured to manage (e.g., adjust) and coordinate communications by, for example, one or more of: managing or controlling transmission power levels, varying the of time slots of communications, managing bandwidth, access control (authentication and determining services and service level), communication frequencies (e.g., dynamically varying the frequency channels to be used), QoS (e.g., modifying QoS, assigning a particular QoS), load balancing, rate limiting, security parameters (e.g., assign a particular security level or parameter to a user device or provide an encryption key), hand-offs, and other facets of communications. To perform these tasks, the cells may be configured to follow certain rules (e.g., executable program code stored in memory) that may be used by the cells in carrying out these activities. The rules may be propagated from a remote access controller to the cells. Alternately, and as discussed above, a remote access controller may make some or all of the determinations and transmit commands to the cells, which respond accordingly.

Various communication parameters may be used by the cells in exercising the rules (rules for hand-offs or managing communication parameters), such as, for example, channel quality data, latency data, the number user devices being serviced, types of data being communicated by a device, the amount of data be communicated (total and/or per user device) by a device, and other information. The cell also may receive configuration information for one or more devices such as, for example, the encryption key, transmission power, user access lists, and/or frequency channel being used for communications. Such information may be transmitted by the user device, remote access controller, or another cell periodically or intermittently or may be transmitted in response to a control message received from the cell. Cells may receive control messages from a controller or other cell site to configure the cell such as, control messages that control the transmission power level, the encryption key, the frequency channel, and other parameters to be used by the cell. A control message may include one or more packets, frames, commands, requests for status information, and/or requests for configuration information.

As discussed, the cells may coordinate what user devices have access to the network and through which cell the user device will be associated. In addition, in one example embodiment, the cell may be configured to detect unauthorized users, ensure associated user devices do not become associated with other non-affiliated cells, and ensure that user devices need not re-authenticate when moving from cell to cell. The cell may also determine subscription services and communication parameters based on the user device, type of user device, type of subscriber, time of day, week, or month, and/or location of the user device.

The cell also may control and manage distribution of loads. As the traffic through each cell changes, either because the activity of the user devices varies or because of hand-offs of user devices between nodes, the distribution of loads among the cells may change. Highly uneven distribution of loads can affect the communications (e.g., quality of service or QoS) provided to the user devices.

If at any time the cell determines that it has a load that is affecting (or could affect) the communications with user devices which are communicating through it, the cell may execute program code to initiate a load redistribution process to redistribute the load by handing off user devices associated with that cell to a new cell (of the same or a different access type/size). Thus, the cell may transmit a control message to other cell(s), which may respond by transmitting information to the user device that facilitates the hand-off. In an example embodiment, cells may each include a list of the user devices that are associated with it stored in memory and which may be used for load balancing and other functions described herein.

In addition to load balancing, the cells may manage communications to provide QoS. Wireless networks typically require communications to coordinate and maintain communication, particularly when the network must support quality of service (QoS). The dynamic nature of radio frequency (RF) channels may mean that connectivity and connection quality between devices may change from time to time and as mobile device move through the network. Thus, nodes may frequently re-negotiate a QoS or other parameter to maintain coordinated communication. In some embodiments, the type of data in portions (e.g., a threshold number or percentage of the data) of the communications serviced by the cell and/or the desired QoS for a portion of the communications of the cell may be used to determined whether a cell is allocated one or more licensed frequency bands (because often licensed bands can more reliably supply higher QoS)—and if the criteria is not met the cell may be allocated mostly or only unlicensed frequencies. Similarly, the type of data and/or necessary QoS of a user device may be used to determine whether a user device is allocated one or more licensed frequency bands, and if the criteria is not met the device may be allocated an unlicensed frequency. The size and type of data (e.g., QoS needed) can be used to calculate or estimate a timeliness using various communication methods (e.g., determine how fast data can be received and QoS via a license band and unlicensed band) to then select the preferred method.

In one example, prioritization and processing of data may be based on acceptable levels of latency and bandwidth availability. An IP telephone call may be assigned higher queuing and processing priority in order to minimize latency. In addition, to support QoS bandwidth management, for example, may include performing activities which may limit and control the usage of available bandwidth based on a particular user device, a type of user device, and/or a type of data.

Based on QoS related information (or other information), the cell may force a user device to roam or find a new cell with which to associate. Such an occurrence may result, for example, when the cell determines that there is insufficient bandwidth (over any wireless or wired link), or too high a latency to provide a minimal acceptable QoS.

As discussed herein, in one example embodiment the network/cells may manage the frequency channel and/or transmission power levels for cells that are physically located near each other to reduce or prevent interference (and for other purposes) to thereby improve network communications. For example, those cells that are providing overlapping coverage may be allocated different frequency channels. Those cells whose coverage does not overlap may be allocated the same frequency channel but limited in their transmission power levels so as to ensure that their transmissions do not overlap and that they cannot “hear each other” or that user devices do not hear both. In one embodiment, each cell may perform signal strength measurements on the same user devices, which data may be transmitted to each other to facilitate power and frequency control. In addition or alternately, the remote access controller may coordinate frequency and transmission power levels.

Various embodiments of the present invention may have numerous and varied applications. For example, in an urban area a first cell may cover an area that is populated largely with office buildings. An adjacent second cell may cover an area that is populated largely with non-office buildings such as parks and other areas. At the end of work day and people leave the office buildings, the first cell may see a decrease in data traffic and the second sell may see an increase in data traffic as people visit the park. Consequently, it may be desirable to change the modulation scheme of the first cell and the second cell (e.g., to handle more data). In addition, as the second cell reaches capacity it may be desirable to hand-off communications of some user devices from the second cell to the first cell as the second cell approaches a threshold value. Furthermore, it may be desirable to reduce the transmission power of the second cell (and increase the transmission power of others) so that other cells may more readily service locations more distant from second cell (e.g., where communication frequency bands are not readily available) and user devices at the more distant locations may be handed-off.

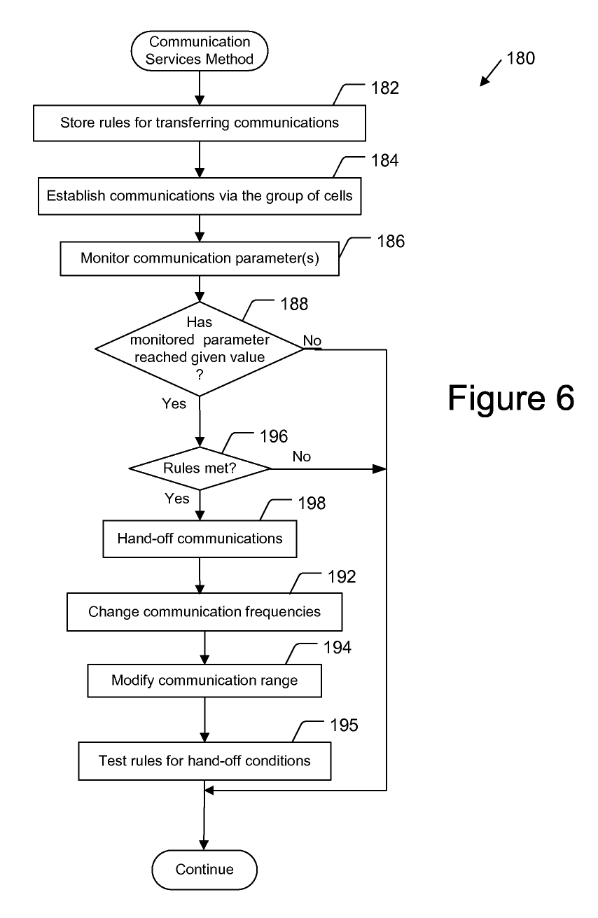

Thus, one embodiment includes method of providing wireless communications services within a first geographical area using a network comprising a group of cells, wherein a plurality of the cells have overlapping coverage areas is provided. Referring to FIG. 6, in this example embodiment the method includes storing rules for transferring user device communications between cells 182; establishing wireless communications with a plurality of user devices via the group of cells 184; monitoring one or more communications parameters of the communications through at least one of the cells of the group 186; determining that one or more communication parameters monitored has reached a first value 188; changing communication frequencies used by a plurality of the cells of the group for wireless communications with the user devices 192; modifying the communication range of one or more cells of the group from a first size to a second size 194; determining, based on the rules, whether one or more wireless communications should be handed-off from a first cell of the group to a second cell of the group 195. Finally, If it is determined that the rule(s) are satisfied 196, the method further includes handing-off one or more wireless communications from a first cell of the group to a second cell of the group in accordance with the determining 198. These steps may performed in the order described here, in the order shown in FIG. 6, or another order. One or more of the steps may be implemented via software executed by one cell, a plurality of cells, a remote access controller, or a combination thereof. In other embodiments, the method steps may be in a different order.

In one example, embodiment some cells may be equipped with mobile telephone capable cells (base stations) while others may be equipped with Wifi (i.e., IEEE 802.11) access points. Some mobile telephones include Wifi communication capabilities (in addition to mobile telephone communication capabilities). Consequently, a mobile telephone's communications may be switched between Wifi communications with one cell and mobile telephone network communications with another cell in accordance with the methods and concerns described herein. Thus, if a cell determines that a mobile telephone user device is not obtaining minimum QoS while communicating (e.g., a voice communication) via Wifi, the user device may be handed-off to another cell providing mobile telephone network communications, preferably seamlessly.

In another example embodiment, a method of providing wireless communication services within a first geographical area using a network comprising a group of cells, wherein a plurality of the cells have overlapping coverage areas, may comprise establishing wireless communications with a plurality of user devices via the group of cells with a first set of quality parameters; monitoring a quality of service parameter of the communications through at least one of the cells of the group; monitoring a load management parameter of the communications through at least one of the cells of the group; and determining that a load management parameter or a quality of service parameter has reached a threshold value. In addition, the method may include handing off one or more communications from a first cell to a second cell, modifying communication frequencies used by a plurality of the cells, and modifying the transmission power of one or more cells of the group to provide the plurality of user devices with substantially the first set quality parameters for communications. One example consequence of this embodiment may allow the network to continue to provide substantially the same quality of communications (e.g., latency, throughput, etc.) to the user devices. The handing off, modifying communication frequencies, and modifying transmission power may facilitate automated re-use of frequency bands of the network and automated allocation of capacity.

One advantage of having multiple wireless cells controlled by an access controller is that communication frequencies (channels) can be re-used in some instances. In its database, the access controller may include or determine information about the location or relative position of (e.g., distance between) one or more of the cells. The access controller also may have or determine information about the transmission power being used by one or more of the cells. Specifically, in some embodiments the access controller may send control messages to determine and/or control the transmission power used by a first cell. Based on this data, the access controller may determine whether one or more nearby cells are sufficiently far enough away (from the first cell) so as not to interfere with, or be interfered with, communications of the first cell when using the same or overlapping frequency bands.

Thus, the size (e.g., radius, diameter, or distance of communication from transceiver) for the cells may change dynamically. By making cells smaller, an increase in capacity per square mile and therefore, in some instances, the capacity per user is provided. To make up for some cells becoming smaller, other nearby and/or adjacent cells may increase in size (e.g., to provide coverage if areas no longer covered by the shrinking cells). The increase or decrease in size of the cell may be accomplished by increasing or decreasing the transmission power (as discussed above) or by using technologies such as MIMO (multiple-input multiple-output communications using dual-array multiple-antenna system) or beam forming. Alternatively, in some embodiments cells may be dynamically split by using multiple antennas or smart antennas that can change from Omni to sector (directional) usage. As discussed, frequency use of the cells may be dynamically reallocated to cells based upon size and/or load. For example, cells approaching a threshold load capacity may be allocated additional frequency bands and nearby cells, with less load, may be assigned fewer frequency bands (de-allocated) to improve the efficiency of overall network's frequency use. In addition or alternately, the cells that need a capacity or are otherwise experiencing high or increasing load, may be allocated one or more licensed frequency bands, instead of, or in addition to one or more unlicensed frequency band(s). Other adjacent or nearby cells (that do not have high capacity loads) may be allocated unlicensed bands. In an alternate embodiment, cells the cells that need a capacity or are otherwise experiencing high or increasing load, may be allocated more or substantially all unlicensed frequency bands, instead of, or in addition to one or more licensed frequency band(s) and other adjacent or nearby cells (that do not have high capacity loads) may be allocated licensed bands.

Location based services may also be provided with the present invention. As an example, and depending the accuracy of the location desired or needed, pico cells may be sufficiently small so that any user devices communicating with a pico cell may be located with sufficient accuracy to provide location based advertising and other services. Alternately, sectorized pico cells may be implemented to provide location with a one third or some other fractions of a cell area. Alternately, feedback from beam forming or MIMO implementations may provide sufficiently accurate location information due to relatively small cell sizes. Such implementations may provide sufficient accuracy even though only one cell is used to determine the location information (as opposed to multiple cells in other prior art methods).

Accordingly, the access controller facilitates the re-use of frequencies more readily. For example, cells that are spaced sufficiently apart and non-overlapping may be allocated the same frequency channel by the access controller. Another advantage is that the access controller can select a cell to service a user device. Thus, by selecting a cell that is not substantially utilized to its maximum capacity (i.e., that is less “crowded”), is communicating less data (per unit of time), or is servicing fewer user devices, better communication services may be provided.

### Communication Protocols:

In various embodiments network cells may comprise wireless transceiver to communicate via varying protocols such as, for example, protocols complying with IEEE 802.11a/b/g, 802.16, Cellular 1G, 2G, 3G, satellite (such as WildBlue®), MMDS, or any other suitable standard. The wireless links may use any suitable frequency band. In some cells, for example, frequency bands may be used that are selected from among ranges of licensed frequency bands (e.g., 6 GHz, 11 GHz, 18 GHz, 23 GHz, 24 GHz, 28 GHz, or 38 GHz band) and unlicensed frequency bands (e.g., 900 MHz, 2.4 GHz, 5.8 GHz, 24 GHz, 38 GHz, or 60 GHz (i.e., 57-64 GHz)). In another example, frequencies may be selected from among other frequency bands including a 75 GHz frequency and a 90 GHz frequency. I

Some cells (e.g., macrocells) may implement conventional mobile telephone networks for mobile telephone communications, including, but not limited to, one or more of AMPS, Cellular 1G, 2G, 3G, GSM (Global System for Mobile communications), PCS (Personal Communication Services) (sometimes referred to as digital cellular networks), and other cellular telephone networks. One or more of these networks may use various access technologies such as frequency division multiple access (FDMA), time division multiple access (TDMA), or code division multiple access (CDMA) (e.g., some of which may be used by 2G devices) and others may use CDMA2000 (based on 2G Code Division Multiple Access), WCDMA (UMTS)—Wideband Code Division Multiple Access, or TD-SCDMA (e.g., some of which may be used by 3G devices).

Some cells (e.g., microcells 105) may communicate using protocols substantially conforming to the IEEE 802.11a/b/g/n (also referred to as WiFi), or IEEE 802.16 (also referred to as WiMAX). Some cells (e.g., picocells 111) may communicate using protocols substantially conforming to the IEEE 802.11b/g standard, IEEE 802.16 (also referred to as WiMAX) or 802.15 (including embodiments of Bluetooth®) or Ultrawideband (UWB). Thus, in some embodiments picocells may comprise the same or similar wireless transceiver (or protocol) as a microcell, which may be configured to transmit with less power (than a microcell) to provide a smaller cell size.

### User Devices:

A variety of user devices may access a wireless communication network 102, 106, 110. Examples of user devices may include Voice-over IP endpoints, personal digital assistants (PDAs), mobile telephones, game systems, computers, routers, local area networks, power meters, security systems, alarm systems (e.g., fire, smoke, carbon dioxide, etc.), stereo systems, televisions, and fax machines.

The various user devices may have different network QoS requirements. Typically, the devices are categorized into one of a plurality of groups, wherein each group corresponds to a differentiated data service among the networks. For example, high quality voice (Voice over Internet Protocol (VoIP)) data requires low latency, low jitter, and medium bandwidth and may tolerate some lost packets. Gaming data may require low latency, low jitter, low packet loss, and low to medium bandwidth both upstream and downstream. Video data may require relatively low latency, no or low jitter, low packet loss, and high bandwidth. Video data is typically one way (downstream), but in some cases may have interactive functionality in which case the upstream bandwidth requirements typically are low. Audio data typically has substantially the same requirements as video, but with lower bandwidth. Enhanced power distribution services (EPDS) for utility applications, such as, for example, communication with a power meter, require low bandwidth, high reliability, and low packet loss, but may tolerate relatively high latency and jitter. Thus, in summary, each type of data (e.g., the data associated which each device) may be (1) accorded one of a plurality of data services available on one or more of the networks 102, 106, 110. In addition, some embodiments may determine whether to hand-off (or not hand off) a communication based, at least in part, on the type of user device communicating the data and/or the type of data communicated by the user device. As will be evident to those skilled the art, the terms cell and cell site have been used interchangeably throughout herein and are mean to connote the same item, which may be, for example purposes, a Wifi wireless transceiver or a base station (e.g., WiMAX or mobile phone base station).

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing wireless communication services within a first geographical area using a network comprising a group of cells, wherein a plurality of the cells have overlapping coverage areas, the method comprising:
storing rules for transferring user device communications between cells;
establishing wireless communications with a plurality of user devices via the group of cells;
monitoring one or more communications parameters of the communications through at least one of the cells of the group;
determining that one or more communication parameters monitored has reached a first value;
changing communication frequencies used by a plurality of the cells of the group for wireless communications with the user devices;
modifying the communication range of one or more cells of the group from a first size to a second size;
determining, based on the rules, whether one or more wireless communications should be handed-off from a first cell of the group to a second cell of the group; and
handing-off one or more wireless communications from a first cell of the group to a second cell of the group in accordance with said determining.

2. The method of claim 1, wherein the one or more communications parameters includes a quality of service parameter.

3. The method of claim 1, wherein the one or more communications parameters includes a data capacity parameter.

4. The method of claim 1, wherein the one or more communications parameters includes network load balancing parameters.

5. The method of claim 1, wherein the one or more communications parameters includes user cost information of the wireless communication.

6. The method of claim 1, wherein the user devices having communications handed-off include stationary user device;

7. The method of claim 1, wherein wireless communications of a first cell are managed by a first network provider operating a first network and wireless communications of a second cell are managed by a second network provider operating a second network, and further comprising;
handing-off wireless communications between the first network and the second network; and
providing a financial hand-off between said first network provider and said second network provider associated with the communications hand-off.

8. The method of claim 7, further comprising tracking amounts of data communicated by the first network and second network for said communications hand-off.

9. The method of claim 7, further comprising tracking the duration of the communications handed-off.

10. The method of claim 1, wherein the second size is at least twice as large as the first cell size.

12. The method of claim 1, further comprising transmitting a request for authorization to hand-off a wireless communication.

13. The method of claim 12, further comprising determining whether user authorization is required for the hand-off.

14. The method of claim 12, further comprising receiving an affirmative response to said request prior to handing-off the communication.

15. The method of claim 1, wherein at least one cell of the group comprises a wireless transceiver substantially compliant with an IEEE 802.11 standard.

16. The method of claim 15, wherein at least one cell of the group comprises a base station configured to provide communications substantially compliant with a mobile telephone communications standard.

17. The method of claim 1, wherein one of said rules comprises handing off a communication based on information of the user device.

18. The method of claim 1, wherein at least one cell comprises a wireless transceiver substantially compliant with an IEEE 802.16 standard.

19. The method of claim 1, wherein one of said rules comprises handing off a communication based on information of the data communicated.

20. The method of claim 1, further comprising changing the method of modulation used by one or more cells of the group.

21. A method of providing wireless communication services within a first geographical area using a network comprising a group of cells that include a plurality of Wifi cells and a plurality of mobile telephone base station cells, wherein one or more Wifi cells and one or more mobile base station cells have overlapping coverage areas with each other, the method comprising:
storing rules for transferring user devices communications between cells;
establishing wireless communications with a plurality of user devices via the group of cells;
monitoring one or more communications parameters of communications through at least some cells of the group;
determining that one or more communication parameters has reached a threshold value;
changing one or more communication parameters of one or more cells of the group;
determining, based on the rules, whether the wireless communication should be handed-off from a Wifi cell to a base station cell; and
handing-off one or more wireless communications from the Wifi cell to a mobile telephone base station cell in accordance with said determining.

22. The method of claim 21, wherein the one or more communications parameters includes a quality of service parameter.

23. The method of claim 21, wherein the one or more communications parameters includes the available capacity of a Wifi cell.

24. The method of claim 21, wherein the one or more communications parameters includes a network load balancing parameter.

26. The method of claim 21, wherein the one or more communications parameters includes a user cost information of the wireless communication.

27. The method of claim 21, wherein wireless communications of a Wifi cell are managed by a first network provider operating a first network and wireless communications of a base station cell are managed by a second network provider operating a second network, and further comprising;
handing-off wireless communications between the first network and the second network; and
providing a financial transfer between said first network provider and said second network provider associated with the communications handed-off.

28. The method of claim 21, further comprising modifying the communication range of one or more Wifi cells from a first size to a second size and wherein the first size is at least twice as large as the second size.

30. The method of claim 21, further comprising transmitting a request for authorization to hand-off the wireless communication from the Wifi cell to the base station cell.

31. The method of claim 30, further comprising determining whether authorization is required for the hand-off.

32. The method of claim 21, further comprising changing the method of modulation used by one or more Wifi cells.

33. The method of claim 21, further comprising transmitting a request for authorization to hand-off the wireless communication from a mobile telephone base station to a Wifi cell.

34. A method of providing wireless communication services within a first geographical area using a network comprising a group of cells, wherein a plurality of the cells have overlapping coverage areas, the method comprising:
establishing wireless communications with a plurality of user devices via the group of cells with a first set of quality parameters;
monitoring a quality of service parameter of the communications through at least one of the cells of the group;
monitoring a load management parameter of the communications through at least one of the cells of the group;
determining that a load management parameter or a quality of service parameter has reached a threshold value;
handing off one or more communications from a first cell to a second cell;
modifying communication frequencies used by a plurality of the cells; and
modifying the size of one or more cells of the group.

35. The method of claim 35, wherein said handing off, modifying communication frequencies, and modifying transmission power facilitate automated re-use of frequency bands of the network.
